(19) United States
(12) Patent Application Publication
(10) Pub. No.: US 2014/0075509 A1
(43) Pub. Date: Mar. 13, 2014

(54) PERFORMING A GROUP AUTHENTICATION AND KEY AGREEMENT PROCEDURE

(71) Applicant: Nokia Corporation, Espoo (FI)

(72) Inventors: Silke Holtmanns, Klaukkala (FI); Da Jiang Zhang, Beijing (CN)

(21) Appl. No.: 14/119,665

(22) PCT Filed: May 26, 2011
(86) PCT No.: PCT/CN2011/074693

§ 371 Date: Nov. 22, 2013

(51) Int. Cl. H04L 29/06

(52) U.S. Cl. CPC H04L 63/0869
USPC 726/3

(57) ABSTRACT

Provided are a method, a corresponding apparatus and a computer program product for performing a group authentication and key agreement procedure. A method comprises initiating, by a master device in a group of devices, a group authentication and key agreement procedure towards an authentication entity, wherein a shared group key is defined for use in the group authentication and key agreement procedure; performing mutual authentication between the master device and the authentication entity based upon the shared group key; and performing mutual authentication between the authenticated master device and other devices in the group based upon the shared group key for completion of the group authentication and key agreement procedure. With the claimed invention, the impact of the signaling overhead on a network can be significantly decreased without substantive modification to the existing architecture of the network.

### FIELD OF THE INVENTION

Embodiments of the present invention generally relate to wireless communication. More particularly, embodiments of the present invention relate to a method, an apparatus, and a computer program product for performing a group authentication and key agreement procedure on a group of communication devices, e.g., machine-type-communication devices.

### BACKGROUND OF THE INVENTION

Various abbreviations that appear in the specification and/or in the drawing figures are defined as below:
3GPP Third Generation Partnership Project
LTE Long Term Evolution
BS Base Station
MS Mobile Station
MME Mobility Management Entity
UE User Equipment
IMSI International Mobile Subscriber Identity
ASME Access Security Management Entity
TMSI Temporary Mobile Subscriber Identity
MTC Machine Type Communication
HSS Home Subscriber Server
IMEI International Mobile Equipment Identity
AV Authentication Vector
USIM Universal Subscriber Identity Module
AUTN Authentication Token
RAND Random Challenge
GPRS General Packet Radio Service
SGSN Serving GPRS Support Node
XRES Expected Response
CK Cipher Key
IK Integrity Key
AK Anonymity Key
XMAC Expected Message Authentication Code
MAC Message Authentication Code
AuC Authentication Center
AKA Authentication and Key Agreement

An AKA procedure is a procedure that has been employed by many communication systems of today for the purpose of improving system security and robustness. One such an AKA procedure has been detailed in 3GPP Technical Specifications 33.102 and 33.401, which are incorporated herein by reference in their entirety. The AKA procedure, which may involve a challenge-response authentication procedure as known in the art, will inevitably cause certain amount of signaling overhead. When the number of devices to be authenticated in the AKA procedure is relatively low, it will merely cause small amount of overhead for the network. However, in a situation where devices to be simultaneously authenticated are numerous, it will generate tremendous signaling overhead that may burden the bandwidth and processing capability of the network. This is especially true for machine-type communications in which many MTC devices formed in groups will initiate their own AKA procedures towards the network simultaneously and thereby make negative impact on the network. For more information regarding MTC communications, see 3GPP Technical Report 33.868, which is also incorporated herein by reference in its entirety.

Therefore, what is needed in the prior art is means for performing a group AKA procedure on a group of devices in an efficient and secure manner such that the impact of signaling overhead on the network could be decreased.

### SUMMARY OF THE INVENTION

A method, an apparatus, and a computer program product are therefore provided for performing a group AKA procedure on a group of devices. In particular, a method, an apparatus and a computer program product are provided where a master device in a group of devices, upon completion of its own authentication with the network (i.e., authentication entities), may authenticate other devices in the group on behalf of the network. Thus, for example, the impact of the signaling overhead on the network may be decreased without substantive modification to the existing architecture of the network.

One embodiment of the present invention provides a method. The method comprises initiating, by a master device in a group of devices, a group authentication and key agreement procedure towards an authentication entity, wherein a shared group key is defined for use in the group authentication and key agreement procedure. The method also comprises performing mutual authentication between the master device and the authentication entity based upon the shared group key. Additionally, the method comprises performing mutual authentication between the authenticated master device and other devices in the group based upon the shared group key for completion of the group authentication and key agreement procedure.

In one embodiment, the master device is selected by an owner of the group of devices, an owner of the master device or a network operator.

In another embodiment, a plurality of different shared group keys are defined for a plurality of different groups of devices such that the device has a plurality of the shared group keys based upon the groups to which it belongs.

In an additional embodiment, the performing mutual authentication is based upon a challenge-response authentication procedure.

In one embodiment, the method further comprises sending, from the master device, to the authentication entity a message regarding results of the group authentication and key agreement procedure.

In another embodiment, the method further comprises instructing, by the master device, one or more devices that have failed in the group authentication and key agreement procedure to initiate an authentication and key agreement procedure towards the authentication entity individually.

In an additional embodiment, the method further comprises generating, for one or more devices that have been successfully authenticated in the group authentication and key agreement procedure, a respective new shared key based upon one or more device specific parameters and an intermediate group key derived from the shared group key.

In another embodiment, the one or more device specific parameters are one or more of an existing specific key, an international mobile subscriber identity, a temporary mobile subscriber identity, and an international mobile equipment identity of the device.

In one embodiment, the existing specific key is a shared key derived from a shared root key between the device and an authentication center, and the respective new shared key is derived from the existing specific key and the intermediate group key.

An additional embodiment of the present invention provides an apparatus. The apparatus comprises means for initiating, by a master device in a group of devices, a group authentication and key agreement procedure towards an authentication entity, wherein a shared group key is defined for use in the group authentication and key agreement procedure. The apparatus also comprises means for performing mutual authentication between the master device and the authentication entity based upon the shared group key. Additionally, the apparatus comprises means for performing mutual authentication between the authenticated master device and other devices in the group based upon the shared group key for completion of the group authentication and key agreement procedure.

In one embodiment, the master device is selected by an owner of the group of devices, an owner of the master device or a network operator.

In another embodiment, a plurality of different shared group keys are defined for a plurality of different groups of devices such that the device has a plurality of the shared group keys based upon the groups to which it belongs.

In an additional embodiment, the performing mutual authentication is based upon a challenge-response authentication procedure.

In one embodiment, the apparatus further comprises means for sending, from the master device, to the authentication entity a message regarding results of the group authentication and key agreement procedure.

In another embodiment, the apparatus further comprises means for instructing, by the master device, one or more devices that have failed in the group authentication and key agreement procedure to initiate an authentication and key agreement procedure towards the authentication entity individually.

In an additional embodiment, the apparatus comprises means for generating, for one or more devices that have been successfully authenticated in the group authentication and key agreement procedure, a respective new shared key based upon one or more device specific parameters and an intermediate group key derived from the shared group key.

In a further embodiment, the one or more device specific parameters are one or more of an existing specific key, an international mobile subscriber identity, a temporary mobile subscriber identity, and an international mobile equipment identity of the device.

In one embodiment, the existing specific key is a shared key derived from a shared root key between the device and an authentication center, and the respective new shared key is derived from the existing specific key and the intermediate group key.

One embodiment of the present invention provides an apparatus. The apparatus comprises at least one processor and at least one memory including compute program code, the at least one memory and the computer program code configured to, with the at least one processor, cause the apparatus to at least perform: initiating, by a master device in a group of devices, a group authentication and key agreement procedure towards an authentication entity, wherein a shared group key is defined for use in the group authentication and key agreement procedure; performing mutual authentication between the master device and the authentication entity based upon the shared group key; and performing mutual authentication between the authenticated master device and other devices in the group based upon the shared group key for completion of the group authentication and key agreement procedure.

One embodiment of the present invention provides a computer program product. The computer program product comprises at least one computer readable storage medium having a computer readable program code portion stored thereon. The computer readable program code portion comprises program code instructions for initiating, by a master device in a group of devices, a group authentication and key agreement procedure towards an authentication entity, wherein a shared group key is defined for use in the group authentication and key agreement procedure. The computer readable program code portion also comprises program code instructions for performing mutual authentication between the master device and the authentication entity based upon the shared group key. The computer readable program code portion further comprises program code instructions for performing mutual authentication between the authenticated master device and other devices in the group based upon the shared group key for completion of the group authentication and key agreement procedure.

With certain embodiments of the present invention, the signaling overhead caused by performance of too many AKA procedures on a group of device will be decreased. Additionally, with the shared group key, secure communications between the group of devices and the network may be improved.

Other features and advantages of the embodiments of the present invention will also be understood from the following description of specific embodiments when read in conjunction with the accompanying drawings, which illustrate, by way of example, the principles of embodiments of the invention.

### BRIEF DESCRIPTION OF THE DRAWINGS

A more complete understanding of various embodiments of the present invention and the advantages thereof may be acquired by referring to the following description in consideration of the accompanying drawings, in which like reference numbers indicate like features, and wherein:

FIG. 1 exemplarily illustrates a simplified 3GPP network that provides an environment and structure for application of the principles of the present invention;

FIG. 2 exemplarily illustrates a flow chart of a method for performing a group AKA procedure on a group of devices according to an embodiment of the present invention;

FIG. 3 is a flow chart exemplarily illustrating a method for performing a group AKA procedure on a group of devices under a LTE network according to an embodiment of the present invention; and

FIG. 4 is a block diagram illustrating an apparatus for performing a group AKA procedure according to an embodiment of the present invention.

### DETAILED DESCRIPTION OF EMBODIMENTS

In the following description of the various embodiments, reference is made to the accompanying drawings, which form a part thereof, and in which is shown by way of illustration various embodiments in which the present invention may be practiced. It is to be understood by those skilled in the art that other embodiments may be utilized and structural and functional modifications may be made without departing from the scope and spirit of the present invention,

In one embodiment of the present invention, a master device in a group of devices may initiate a group AKA procedure towards the network, e.g., an authentication entity. For the group AKA procedure, a shared group key is predefined so as to perform mutual authentication between master device and the network. When the master device has been successfully authenticated, it will authenticate other devices in the group in place of the authentication entity. In another embodiment of the present invention, if one or more devices in the group fail in the authentication, then each of them will initiate an individual AKA procedure with the authentication entity. In an additional embodiment of the present invention, the master device will send to the authentication entity a message regarding the results of the group AKA procedure.

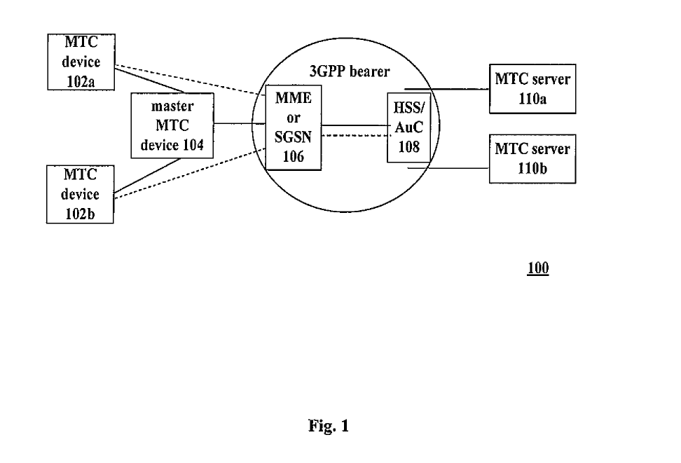

FIG. 1 exemplarily illustrates a simplified 3GPP network 100 that provides an environment and structure for application of the principles of the present invention. The network 100 as illustrated in FIG. 1 includes a MTC device 102a, a MTC device 102b, and a master MTC device 104 that are located at an access portion of the network 100. Additionally, the network 100 includes a MME (used in a LTE system) or SGSN (used in a 3G system) 106 and a HSS/AuC 108 that are located in the 3GPP bearer as illustrated by a circle, wherein the MME or SGSN 106 and HSS/AuC 108 belong to network-side (as compared to the access portion) entities and the MME or SGSN 106 may also be referred to as an authentication entity. Furthermore, the network 100 includes a MTC server 110a and a MTC server 110b that are connected to the 3GPP bearer and handle various transactions regarding a group of MTC devices, e.g., the group consisting of the MTC device 102a, 102b and 104 as illustrated in FIG. 1. It should be understood that the network 100 is provided as an example of one embodiment and should not be construed to narrow the scope or spirit of the disclosure in any way.

In a conventional AKA procedure, each device in a group of devices would have to initiate an AKA procedure towards the network individually. As illustrated with dotted lines in FIG. 1, the MTC devices 102a and 102b each initiate a AKA procedure towards the MME or SGSN 106 through their respective shared root key Kᵢ which has been stored in the USIM. Upon receipt of the AKA procedure requests, the MME or SGSN 106, as an intermediate party, may interact with the HSS/AuC 108 so as to perform respective challenge-response procedures for authenticating the MTC devices 102a and 102b. Although only three MTC devices (including the master MTC device) are illustrated herein for exemplary purpose, there may be a group of hundreds of MTC devices in practice. When such a number of MTC devices initiate AKA procedures separately and simultaneously, it is unquestionable that the generated signaling overhead cause tremendous impact on the MME or SGSN 106 and HSS/AuC 108.

An efficient way to alleviate the above impact on the network is to decrease the number of performed AKA procedures at the network side. To this end, embodiments of the present application propose performing a group AKA procedure on a group of devices, e.g., MTC devices. In the group AKA procedure, a master MTC device 104 may be selected or designated in a group of MTC devices beforehand by a network operator, an owner of the master MTC device, or an owner of the group of MTC devices (e.g., a company, such as a power company). Then the master MTC device 104 may initiate a group AKA procedure towards the authentication entity through a predefined shared group key K_{group} that is similar to the key Kᵢ.

Upon completion of the AKA procedure between the master MTC device 104 and network-side entities, i.e., MME or SGSN 106 and HSS/AuC 108, the master MTC device 104 may authenticate other MTC devices in the group on behalf of the network-side entities. In other words, other MTC devices in the group may perform individual AKA procedures no longer with network-side entities but with the master MTC device 104. As such, the signaling overhead at the network side would be significantly decreased because the AKA procedure has been performed only once at the network side.

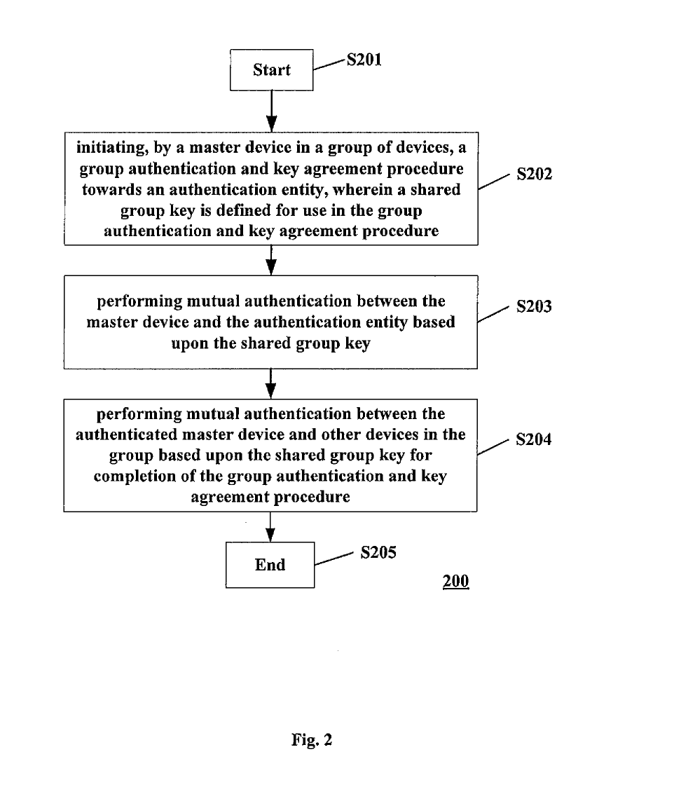

FIG. 2 exemplarily illustrates a flow chart of a method 200 according to an embodiment of the present invention. The method starts at step S201 and proceeds to step S202 at which the method 200 initiates, by a master device in a group of devices, a group AKA procedure towards an authentication entity, wherein a shared group key is defined for use in the group AKA procedure. In one embodiment, the master device is selected by an owner of the group of devices, an owner of the master device or a network operator. In other words, any one of devices in the group may play a role as the master device to initiate the group AKA procedure as needed. In another embodiment, a plurality of different shared group keys are defined for a plurality of different groups of devices such that the device has a plurality of the shared group keys based upon the groups to which it belongs.

Upon initiation of the group AKA procedure, the method 200 advances to step S203. At step S203, the method 200 performs mutual authentication between the master device and the authentication entity based upon the shared group key. In one embodiment, the mutual authentication may be performed based upon a challenge-response authentication procedure in which the shared group key is used instead of a conventional key. As is known to those skilled in the art, the challenge-response authentication procedure is successful only when the device has authenticated the network and the network has authenticated the device.

Upon authentication of the master device and the network, the method 200 proceeds to step S204 at which the method 200 performs mutual authentication between the authenticated master device and other devices in the group based upon the shared group key for completion of the group AKA procedure. Like step S203, the mutual authentication herein also may involve a challenge-response authentication procedure.

Although not shown in FIG. 2, the method 200 may comprise additional steps in various embodiments. For example, in one embodiment, the method 200 may instruct, by the master device, one or more devices that have failed in the group AKA procedure to initiate new AKA procedures towards the authentication entity individually. In another embodiment, the method 200 may send, from the master device, to the authentication entity a message regarding results of the group AKA procedure; thereby, the authentication entity can be aware of which devices in the group have passed through the group AKA procedure. In an additional embodiment, the method 200 may generate, for one or more devices that have been successfully authenticated in the group AKA procedure, a respective new shared key based upon one or more device specific parameters and an intermediate group key derived from the shared group key, wherein the one or more device specific parameters are one or more of an existing specific key, an international mobile subscriber identity, a temporary mobile subscriber identity, and an international mobile equipment identity of the device. In one embodiment, the existing specific key is a shared key derived from a shared root key between the device and an AuC, and the respective new shared key is derived from the existing specific key and the intermediate group key.

Finally, the method 200 ends at step S205.

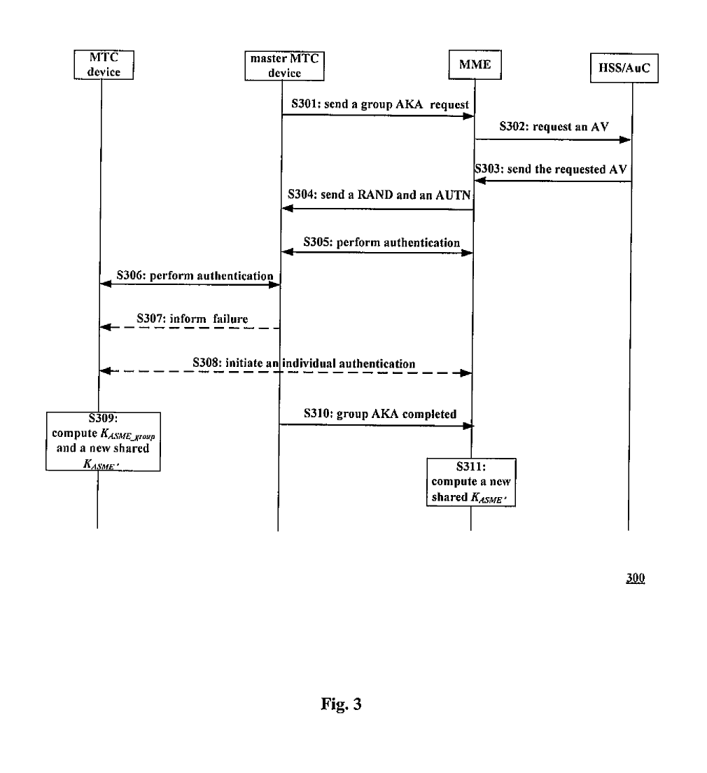

For a better understanding of the embodiments of the present invention, a more complete and detailed example of a group AKA procedure will now be described with reference to FIG. 3, illustrating a method 300 for performing a group AKA procedure on a group of devices (e.g., embodied as MTC devices) under the LTE system. For proper implementation of the method 300, it is assumed that a group of MTC devices has been registered to the network previously and each registered MTC device has a shared key K_{ASME} with the network, though FIG. 3 only illustrates for brevity one MTC device and one master MTC device that are in a same group. Further, it is assumed that a group key K_{group} dedicated for the group AKA procedure has been defined and stored in each device in the group, e.g. on the USIM. Such a group key K_{group} can be securely pushed to the device from the network based upon secure communication preestablished under the protection of the unique shared root key Kᵢ or a shared key derived from Kᵢ.

Based upon the above assumptions or a scenario established thereby, the method 300 starts at step S301, wherein the master MTC device, which can be selected from the group by an owner of the group of devices, an owner of the master device, or a network operator, sends a group AKA procedure request to the MME. Upon receipt of the group AKA procedure request, the MME, at step S302, requests an AV from the HSS/AuC. Due to the previous registration of the MTC devices to the network or an indicator indicative of the group AKA procedure in the request, the HSS/AuC determines that this request is in relation to a group AKA procedure. Thus, in order to assist in the group AKA procedure, it will generate an AV that includes, for example, four components, i.e., a RAND, an AUTN, a XRES, and a K_{ASME-GROUP}. The component K_{ASME-GROUP} is a shared intermediate key derived from the key K_{group}. Regarding how to derive such a shared intermediate key, reference may be made to for example Annex of 3GPP TS 33.401. Alternatively, with respect to the components RAND and AUTN, each of them can be substituted by new components RAND_{group} and AUTN_{group} dedicated for a group AKA procedure, respectively. At step S303, in response to the request from the MME, the HSS/AuC sends the AV including the above four components to the MME.

Upon receiving the AV from the HSS/AuC, the MME, at Step S304, forwards the components RAND and AUTN to the master MTC device. The master MTC device, more particularly, its USIM, upon receipt of the RAND and AUTN, at step S305, first authenticates the MME by computing XMAC and comparing it with MAC included in AUTN. If XMAC equals MAC, then the master MTC device determines the MME is a trusted entity; otherwise, the master MTC device will abandon or abort the group AKA procedure this time and may attempt to reinitiate a group AKA procedure after a certain time interval. In one embodiment, when number of attempts to reinitiate the group AKA procedure exceeds a predefined limit, a new master device should be selected or assigned to initiate the group AKA procedure, Upon successfully authenticating the MME, the master MTC device generates a response RES based upon the shared group key K_{group} and RAND. Afterwards, the master MTC device sends the response RES back to the MME,

To authenticate the master MTC device, the MME simply verifies that the response RES received from the master MTC device equals the XRES received in the AV. Once the response RES equals the XRES, authentication of the master MTC device towards the wireless network has been successfully completed. Alternatively, subsequent to the above mutual authentication, the master MTC device may compute a new shared key K_{ASME}′ based upon the intermediate key K_{ASME-GROUP} derived from K_{group} and one or more device specific parameters. The one or more device specific parameters may be one or more of an existing specific key, e.g., K_{ASME}, or other identifies, e.g., IMSI, TMST or IMEI. For example, the key K_{ASME}′ can be calculated, e.g., by an equation as below.

K_{ASME}′=K_{ASME}⊕K_{ASME-GROUP} (1)

The resulting K_{ASME}′ is used for further secure communication with the network. For example, the K_{ASME}′ may be used to generate keys for other layers, such as the Non-Access Stratum, Access Stratus, and user plane. It should be noted that the above generation of the key K_{ASME}′ is not necessary when the old K_{ASME} is still suitable for further secure communication.

Having been successfully authenticated, the master MTC device, at step S306, sends RAND and AUTN to others devices in the group so as to perform the mutual authentication between itself and each of other devices in the group. Similar to the step S305, each of other devices in the group performs authentication operations on the master MTC device to assure such a master MTC device is a trusted master device rather than a masquerader of the master device. Likewise, upon successfully authenticating the master MTC device, the MTC device in the group generates a respective response RES based upon the shared group key K_{group} and RAND and then forwards the RES to the master MTC device. Similarly, the master MTC device determines whether the RES equals the XRES. If this is the case, it indicates that the MTC device passes through the authentication; otherwise, optionally, at step S307, the master MTC device informs the MTC device of failure in the authentication. Then, alternatively or additionally, the MTC device that fails in the authentication may initiate an individual AKA procedure towards the network at step S308. Upon successful authentication by the master MTC device, at step S309, the MTC device may alternatively computes its own K_{ASME}′ based upon its own existing specific key, e.g., K_{ASME}, which may be unusable now, or its own identifies, e.g., IMSI, TMSI or MEI. Alternatively, the MTC device may apply the equation (1) as discussed above with respect to the master MTC device to compute its own K_{ASME}′ for further secure communication with the network.

The master device, at step S310, may send to the MME a message regarding the results of the group AKA procedure so that the MME may know which devices in the group have passed through the group AKA procedure. Similar to the MTC device, the MME may also compute, at step S311, a respective new shared key K_{ASME}′ for further secure communication.

Although the foregoing has taken the LTE system and the group of the MTC devices as an example to describe an embodiment of the present invention, the present invention should not be limited thereto. A person skilled in the art can understand that the above method 300 may also be implemented, for example, in a 3G system and other types of a group of devices by some modifications. For example, when the method 300 is implemented in the 3G system, the above keys K_{ASME} and K_{ASME-GROUP} in the LTE system may be replaced by keys IK and CK, and IK_{group} and CK_{group}, respectively. Similarly, the SGSN in the 3G system will play the same role as the MME in the LTE system. In addition, in view of the fact that a person skilled in the art, based upon the disclosure and teaching of the present application, can implement the embodiments of the present invention without any additional efforts, further details regarding how to derive and use keys of various levels are omitted herein for not obscuring embodiments of the present invention unnecessarily with the prior art.

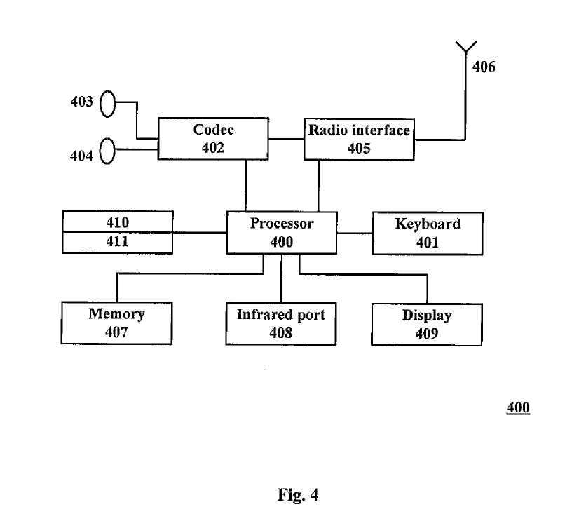

FIG. 4 is a schematic diagram of an apparatus 400 according to another embodiment of the present invention, which implements relevant steps of methods 200 and 300 as illustrated in FIGS. 2 and 3. The apparatus as illustrated in FIG. 4 is only an example of the electronic devices in which the present invention is implemented. In certain embodiments, the apparatus as illustrated in FIG. 4 may be a personal digital assistant (PDA), a mobile phone, an electronic card reader, a sensor device, etc. As illustrated in FIG. 4, the apparatus 400 may comprise at least one processor 400, a keyboard 401, a codec circuitry 402, a microphone 403, an ear-piece 404, a radio interface circuitry 405, an antenna 406, at least one memory 407 storing computer program code, an infrared port 408, a display 409, a smart card 410 (e.g., an USIM card according to embodiments of the present invention), and a card reader 411. Individual circuits and elements are all of a type well known in the art and some of them are omitted herein so as not to obscuring embodiments of the present invention unnecessarily. As illustrated in FIG. 4, the memory 407 and the computer program code as stored therein are configured to cause the processor 400 to perform relevant steps in methods 200 and 300 as described in connection with FIGS. 2 and 3.

In addition, exemplary embodiments of the present invention have been described above with reference to block diagrams and flowchart illustrations of methods, apparatuses (i.e., systems). It should be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The foregoing computer program instructions can be, for example, sub-routines and/or functions. A computer program product in one embodiment of the invention comprises at least one computer readable storage medium, on which the foregoing computer program instructions are stored. The computer readable storage medium can be, for example, an optical compact disk or an electronic memory device like a RAM (random access memory) or a ROM (read only memory).

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-20. (canceled)

21. A method, comprising:
initiating, by a master device in a group of devices, a group authentication and key agreement procedure towards an authentication entity, wherein a shared group key is defined for use in the group authentication and key agreement procedure;
performing mutual authentication between the master device and the authentication entity based upon the shared group key; and
performing mutual authentication between the authenticated master device and other devices in the group based upon the shared group key for completion of the group authentication and key agreement procedure.

22. The method as recited in claim 21, wherein the master device is selected by an owner of the group of devices, owner of the master device or a network operator.

23. The method as recited in claim 21, wherein a plurality of different shared group keys are defined for a plurality of different groups of devices such that the device has a plurality of the shared group keys based upon the groups to which it belongs.

24. The method as recited in claim 21, wherein the performing mutual authentication is based upon a challenge-response authentication procedure.

25. The method as recited in claim 21, further comprising:
sending, from the master device, to the authentication entity a message regarding results of the group authentication and key agreement procedure.

26. The method as recited in claim 21, further comprising:
instructing, by the master device, one or more devices that have failed in the group authentication and key agreement procedure to initiate an authentication and key agreement procedure towards the authentication entity individually.

27. The method as recited in claim 21, further comprising:
generating, for one or more devices that have been successfully authenticated in the group authentication and key agreement procedure, a respective new shared key based upon one or more device specific parameters and an intermediate group key derived from the shared group key.

28. The method as recited in claim 27, wherein the one or more device specific parameters are one or more of an existing specific key, an international mobile subscriber identity, a temporary mobile subscriber identity, and an international mobile equipment identity of the device.

29. The method as recited in claim 28, wherein the existing specific key is a shared key derived from a shared root key between the device and an authentication center, and the respective new shared key is derived from the existing specific key and the intermediate group key.

30. An apparatus, comprising:
at least one processor, and
at least one memory including compute program code,
the at least one memory and the computer program code configured to, with the at least one processor, cause the apparatus to at least perform:
initiating, by the apparatus in a group of devices, a group authentication and key agreement procedure towards an authentication entity, wherein a shared group key is defined for use in the group authentication and key agreement procedure;
performing mutual authentication between the apparatus and the authentication entity based upon the shared group key; and
performing mutual authentication between the authenticated apparatus and other devices in the group based upon the shared group key for completion of the group authentication and key agreement procedure.

31. The apparatus as recited in claim 30, wherein the apparatus is selected by an owner of the group of devices, owner of the apparatus or a network operator.

32. The apparatus as recited in claim 30, wherein a plurality of different shared group keys are defined for a plurality of different groups of devices such that the device has a plurality of the shared group keys based upon the groups to which it belongs.

33. The apparatus as recited in claim 30, wherein the performing mutual authentication is based upon a challenge-response authentication procedure.

34. The apparatus as recited in claim 30,wherein the apparatus is further caused to perform:
sending to the authentication entity a message regarding results of the group authentication and key agreement procedure.

35. The apparatus as recited in claim 30, wherein the apparatus is further caused to perform:
instructing one or more devices that have failed in the group authentication and key agreement procedure to initiate an authentication and key agreement procedure towards the authentication entity individually.

36. The apparatus as recited in claim 30, wherein the apparatus is further caused to perform:
generating, for one or more devices that have been successfully authenticated in the group authentication and key agreement procedure, a respective new shared key based upon one or more device specific parameters and an intermediate group key derived from the shared group key.

37. The apparatus as recited in claim 36, wherein the one or more device specific parameters are one or more of an existing specific key, an international mobile subscriber identity, a temporary mobile subscriber identity, and an international mobile equipment identity of the device.

38. The apparatus as recited in claim 37, wherein the existing specific key is a shared key derived from a shared root key between the device and an authentication center, and the respective new shared key is derived from the existing specific key and the intermediate group key.

39. The apparatus as recited in claim 30, wherein the apparatus is a master device for a group of devices.

40. A computer program product, comprising at least one computer readable storage medium having a computer readable program code portion stored thereon, the computer readable program code portion comprising:
program code instructions for initiating, by a master device in a group of devices, a group authentication and key agreement procedure towards an authentication entity, wherein a shared group key is defined for use in the group authentication and key agreement procedure;
program code instructions for performing mutual authentication between the master device and the authentication entity based upon the shared group key;
program code instructions for performing mutual authentication between the authenticated master device and other devices in the group based upon the shared group key for completion of the group authentication and key agreement procedure.
